(19) United States
(12) Patent Application Publication
(10) Pub. No.: US 2013/0321374 A1
(43) Pub. Date: Dec. 5, 2013

(54) VOLTAGE CONVERTER

(71) Applicant: Qualcomm MEMS Technologies, Inc., San Diego, CA (US)

(72) Inventor: Didier H. Farenc, San Diego, CA (US)

(21) Appl. No.: 13/904,583

(22) Filed: May 29, 2013

Related U.S. Application Data
(60) Provisional application No. 61/653,935, filed on May 31, 2012.

(51) Int. Cl. H02M 3/156

(52) U.S. Cl. CPC H02M 3/156
USPC 345/211; 323/282

(57) ABSTRACT

This disclosure provides systems, methods and apparatus for voltage conversion. In one aspect, a voltage converter includes a first feedback loop monitoring one of two converter outputs of opposite polarity. The converter may further include a second feedback loop for monitoring a weighted sum of the two converter outputs of opposite polarity. In another aspect, a voltage converter may include level shifters for driving switches coupled to a boost inductor. The voltage converter may switch at least one voltage rail coupled to the level shifters from a first voltage level to a second voltage level.

### CROSS-REFERENCE TO RELATED APPLICATIONS

This Patent Application claims priority to U.S. Provisional Patent Application No. 61/653,935 filed May 31, 2012 entitled “Power Supply for Producing Display Driver Rail Voltages,” and assigned to the assignee hereof. The disclosure of the prior Application is considered part of and is incorporated by reference in this Patent Application.

### TECHNICAL FIELD

This disclosure relates to voltage converters, especially voltage converters for driving displays, electromechanical systems and devices, and especially displays that incorporate electromechanical devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element.

The voltage levels needed to drive electromechanical systems can be difficult to efficiently generate. Designs for such power supplies which do not suffer the drawbacks of the prior art would be beneficial.

### SUMMARY

The systems, methods and devices of this disclosure each have several innovative aspects, no single one of which is solely responsible for the desirable attributes disclosed herein.

One innovative aspect of the subject matter described in this disclosure can be implemented in a voltage converter including first and second voltage outputs of opposite polarity, an inductor, a first switch having an input coupled to a first inductor rail voltage and an output coupled to an input of the inductor, and a second switch having an input coupled to an output of the inductor and an input coupled to a second inductor rail voltage. The voltage converter may also include a first level shifter having an output coupled to the first switch to control the on/off state of the first switch and having one or more inputs coupled to one or more level shifter rail voltages and a second level shifter having an output coupled to the second switch to control the on/off state of the second switch and having one or more inputs coupled to the one or more level shifter rail voltages. Control circuitry may be coupled to the first and second level shifters. In addition, a first feedback loop is configured to provide an indication of the output voltage at one of the first and second voltage outputs to the control circuitry, and a second feedback loop configured to provide an indication of a weighted sum of the first and second output voltages to the control circuitry.

Another innovative aspect of the subject matter described in this disclosure can be implemented in a method of operating a voltage converter having at least one pair of outputs of opposite polarity. The method may include monitoring an output voltage at one of the outputs of the pair, monitoring a weighted sum of the output voltages of the pair of outputs, and determining which output to boost based at least in part on the output voltage at one of the outputs and the weighted sum.

Another innovative aspect of the subject matter described in this disclosure can be implemented in a voltage converter including means for boosting a pair of voltage outputs having opposite polarity, means for monitoring an output voltage at one of the outputs of the pair, means for monitoring a weighted sum of the output voltages of the pair of outputs; and control circuitry for determining which output to boost based at least in part on the output voltage at one of the outputs and the weighted sum.

Another innovative aspect of the subject matter described in this disclosure can be implemented in a voltage converter including first and second voltage outputs of opposite polarity, an inductor, a first switch having an input coupled to a first inductor rail voltage and an output coupled to an input of the inductor, and a second switch having an input coupled to an output of the inductor and an input coupled to a second inductor rail voltage. The voltage converter may also include a first level shifter having an output coupled to the first switch to control the on/off state of the first switch and having one or more inputs coupled to one or more level shifter rail voltages and a second level shifter having an output coupled to the second switch to control the on/off state of the second switch and having one or more inputs coupled to the one or more level shifter rail voltages. Control circuitry may be coupled to the first and second level shifters. A switch circuit may be provided configured to switch at least one level shifter rail voltage from one voltage level to a second voltage level during operation of the voltage converter.

Another innovative aspect of the subject matter described in this disclosure can be implemented in a method of operating a voltage converter having at least one pair of outputs of opposite polarity. The method may include driving a level shifter with a first rail voltage and switching from driving the level shifter with the first rail voltage to a second rail voltage different from the first rail voltage.

Another innovative aspect of the subject matter described in this disclosure can be implemented in a voltage converter including means for boosting a pair of voltage outputs having opposite polarity, means for driving a level shifter with a first rail voltage, and means for switching from driving the level shifter with the first rail voltage to a second rail voltage different from the first rail voltage.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a graph illustrating movable reflective layer position versus applied voltage for an IMOD display element.

FIG. 4 is a table illustrating various states of an IMOD display element when various common and segment voltages are applied.

FIG. 5A is an illustration of a frame of display data in a three element by three element array of IMOD display elements displaying an image.

FIG. 5B is a timing diagram for common and segment signals that may be used to write data to the display elements illustrated in FIG. 5A.

FIGS. 6A-6E are cross-sectional illustrations of varying implementations of IMOD display elements.

FIGS. 7A and 7B are schematic exploded partial perspective views of a portion of an electromechanical systems (EMS) package including an array of EMS elements and a backplate.

FIG. 8 is a system block diagram illustrating the generation and application of various voltages to a display when using the drive scheme of FIG. 5B.

FIG. 9 is a schematic diagram illustrating an implementation of a voltage converter for producing the rail voltages of FIG. 8.

FIG. 10 is a schematic diagram illustrating another implementation of a voltage converter for producing the rail voltages of FIG. 8.

FIG. 11 is a flowchart illustrating a mode of operation for a voltage converter.

FIG. 12 is a flowchart illustrating another mode of operation for a voltage converter.

FIGS. 13A and 13B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In one aspect, a voltage converter is utilized to generate at least one pair of output voltages having approximately equal magnitude and opposite polarity relative to a ground reference. The voltage converter may include an inductor connected to voltage rails through switches. Feedback to control circuitry may include one path for monitoring an output voltage, and a second path for monitoring the average voltage of the pair of output voltages. In another aspect, level shifters may be provided to control the switches coupled to the inductor. The level shifter may be driven by voltage rails that are switched form a first voltage level to a second voltage level during operation of the voltage converter.

Particular implementations of the subject matter described in this disclosure can be implemented to realize one or more of the following potential advantages. At startup of the voltage converter, both outputs may be easily increased to the desired output at the same rate so that their voltages may beregulated to be approximately equal. Furthermore, the switches can be controlled with a suitable voltage both during start up and normal operation

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

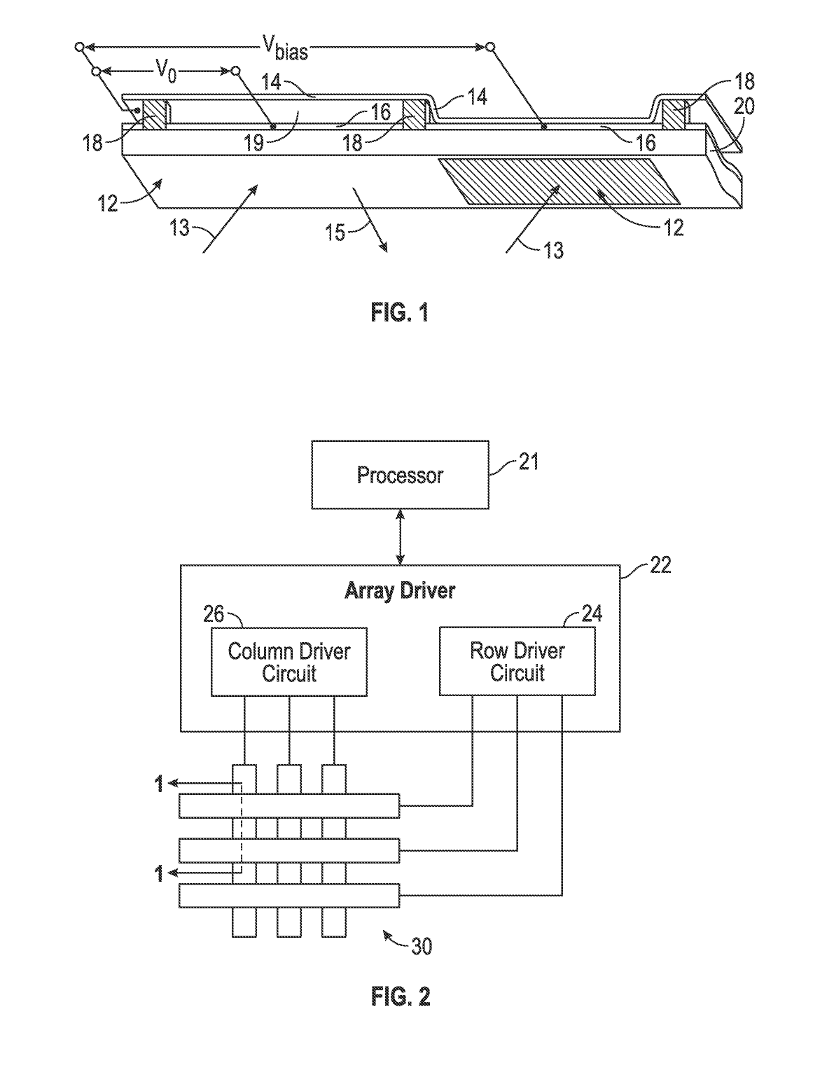

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

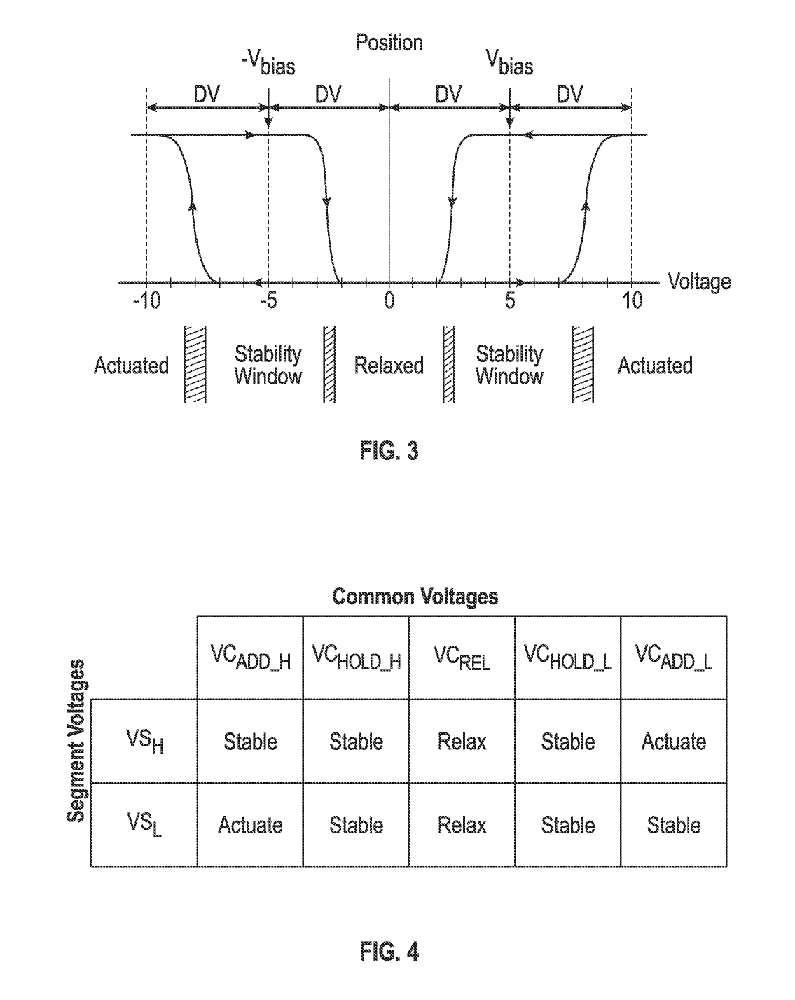

FIG. 3 is a graph illustrating movable reflective layer position versus applied voltage for an IMOD display element. For IMODs, the row/column (i.e., common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously strobed, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VC_{REL} is applied along a common line, all IMOD display elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator display elements or pixels (alternatively referred to as a display element or pixel voltage) can be within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_{—}}_{H} or a low hold voltage VC_{HOLD}_{_{—}}_{L}, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing in this example is the difference between the high VS_{H} and low segment voltage VS_{L}, and is less than the width of either the positive or the negative stability window.

When an addressing, or actuation, voltage is applied on a common line, such as a high addressing voltage VC_{ADD}_{_{—}}_{H} or a low addressing voltage VC_{ADD}_{L}, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having substantially no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

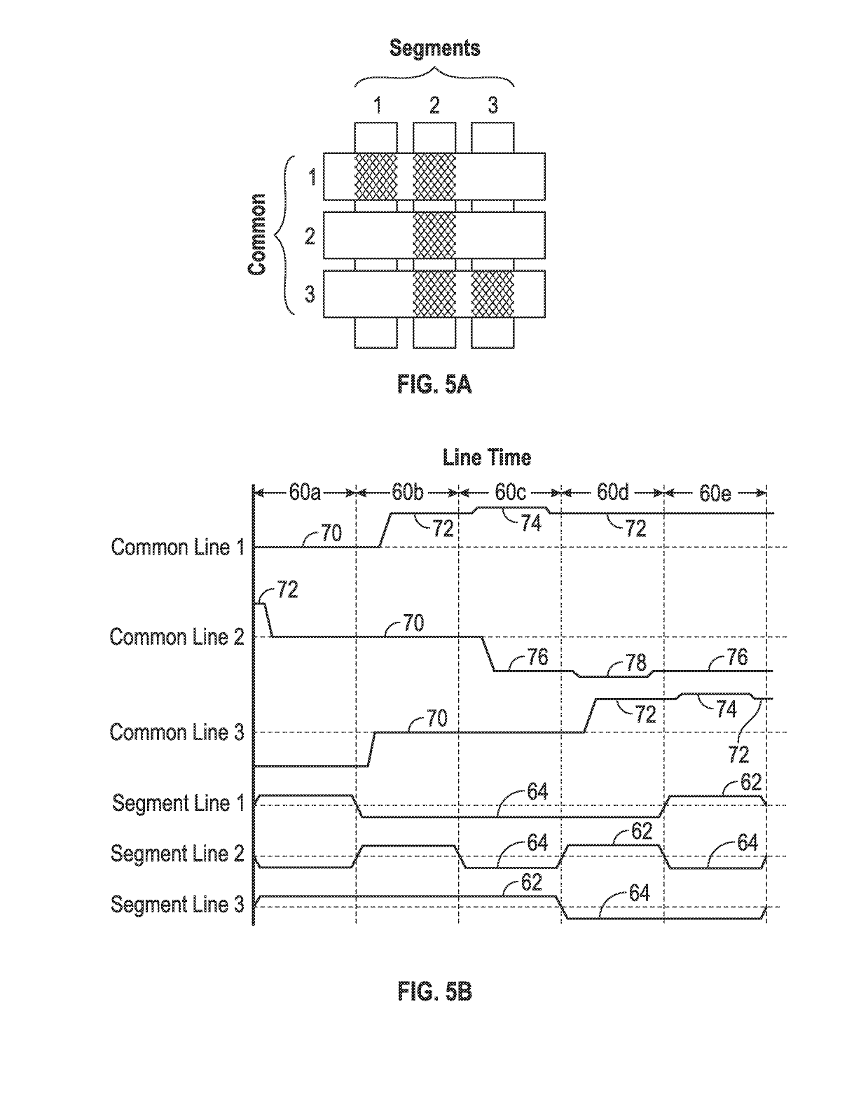

FIG. 5A is an illustration of a frame of display data in a three element by three element array of IMOD display elements displaying an image. FIG. 5B is a timing diagram for common and segment signals that may be used to write data to the display elements illustrated in FIG. 5A. The actuated IMOD display elements in FIG. 5A, shown by darkened checkered patterns, are in a dark-state, i.e., where a substantial portion of the reflected light is outside of the visible spectrum so as to result in a dark appearance to, for example, a viewer. Each of the unactuated IMOD display elements reflect a color corresponding to their interferometric cavity gap heights. Prior to writing the frame illustrated in FIG. 5A, the display elements can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. In some implementations, the segment voltages applied along segment lines 1, 2 and 3 will have no effect on the state of the IMOD display elements, as none of common lines 1, 2 or 3 are being exposed to voltage levels causing actuation during line time 60a (i.e., VC_{REL}-relax and VC_{HOLD}_{_{—}}_{L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the display element voltage across modulators (1,1) and (1,2) is greater than the high end of the positive stability window (i.e., the voltage differential exceeded a characteristic threshold) of the modulators, and the modulators (1,1) and (1,2) are actuated. Conversely, because a high segment voltage 62 is applied along segment line 3, the display element voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the display element voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state. Then, the voltage on common line 2 transitions back to the low hold voltage 76.

Finally, during the fifth line time 60e, the voltage on common line 1 remains at high hold voltage 72, and the voltage on common line 2 remains at the low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 display element array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the display element voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5A. In some other implementations, voltages applied along common lines or segment lines may vary to account for variations in the actuation and release voltages of different modulators, such as modulators of different colors.

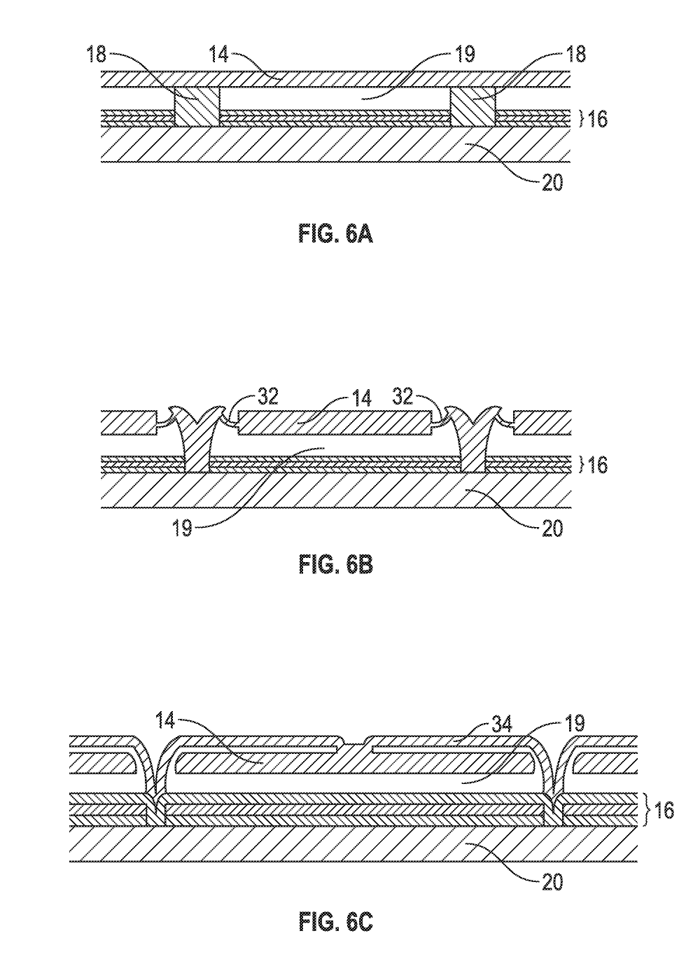

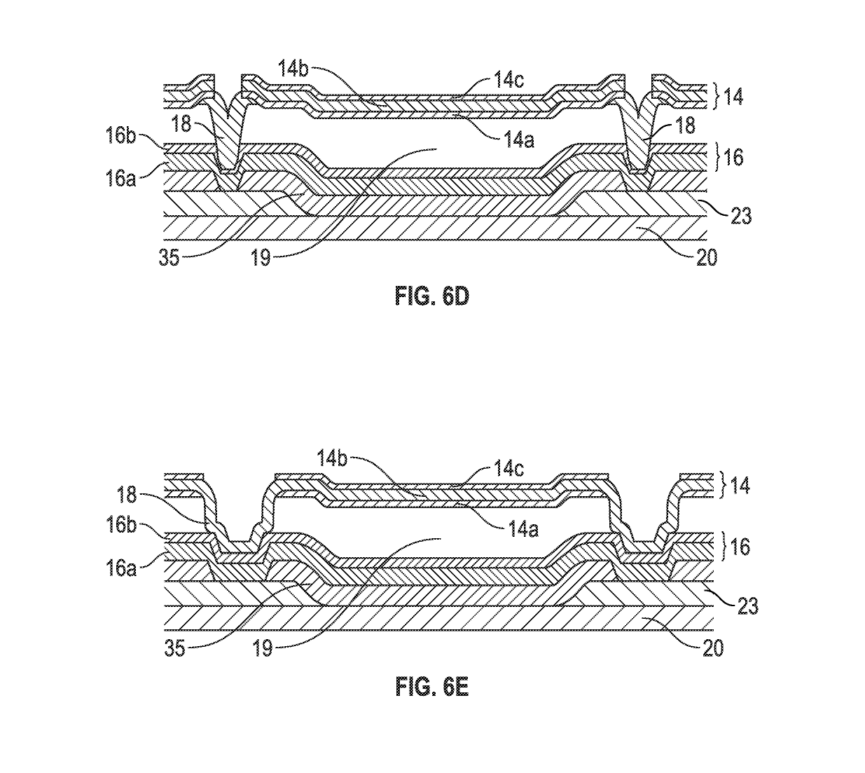

The details of the structure of IMOD displays and display elements may vary widely. FIGS. 6A-6E are cross-sectional illustrations of varying implementations of IMOD display elements. FIG. 6A is a cross-sectional illustration of an IMOD display element, where a strip of metal material is deposited on supports 18 extending generally orthogonally from the substrate 20 forming the movable reflective layer 14. In FIG. 6B, the movable reflective layer 14 of each IMOD display element is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as implementations of “integrated” supports or support posts 18. The implementation shown in FIG. 6C has additional benefits deriving from the decoupling of the optical functions of the movable reflective layer 14 from its mechanical functions, the latter of which are carried out by the deformable layer 34. This decoupling allows the structural design and materials used for the movable reflective layer 14 and those used for the deformable layer 34 to be optimized independently of one another.

FIG. 6D is another cross-sectional illustration of an IMOD display element, where the movable reflective layer 14 includes a reflective sub-layer 14a. The movable reflective layer 14 rests on a support structure, such as support posts 18. The support posts 18 provide separation of the movable reflective layer 14 from the lower stationary electrode, which can be part of the optical stack 16 in the illustrated IMOD display element. For example, a gap 19 is formed between the movable reflective layer 14 and the optical stack 16, when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a and 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23, or dark film layers. The black mask structure 23 can be formed in optically inactive regions (such as between display elements or under the support posts 18) to absorb ambient or stray light. The black mask structure 23 also can improve the optical properties of a display device by inhibiting light from being reflected from or transmitted through inactive portions of the display, thereby increasing the contrast ratio. Additionally, at least some portions of the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. In some implementations, the black mask structure 23 can be an etalon or interferometric stack structure. For example, in some implementations, the interferometric stack black mask structure 23 includes a molybdenum-chromium (MoCr) layer that serves as an optical absorber, an SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, tetrafluoromethane (or carbon tetrafluoride, CF₄) and/or oxygen (O₂) for the MoCr and SiO₂ layers and chlorine (Cl₂) and/or boron trichloride (BCl₃) for the aluminum alloy layer. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate electrodes (or conductors) in the optical stack 16 (such as the absorber layer 16a) from the conductive layers in the black mask structure 23.

FIG. 6E is another cross-sectional illustration of an IMOD display element, where the movable reflective layer 14 is self-supporting. While FIG. 6D illustrates support posts 18 that are structurally and/or materially distinct from the movable reflective layer 14, the implementation of FIG. 6E includes support posts that are integrated with the movable reflective layer 14. In such an implementation, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the IMOD display element is insufficient to cause actuation. In this way, the portion of the movable reflective layer 14 that curves or bends down to contact the substrate or optical stack 16 may be considered an “integrated” support post. One implementation of the optical stack 16, which may contain a plurality of several different layers, is shown here for clarity including an optical absorber 16a, and a dielectric 16b. In some implementations, the optical absorber 16a may serve both as a stationary electrode and as a partially reflective layer. In some implementations, the optical absorber 16a can be an order of magnitude thinner than the movable reflective layer 14. In some implementations, the optical absorber 16a is thinner than the reflective sub-layer 14a.

In implementations such as those shown in FIGS. 6A-6E, the IMOD display elements form a part of a direct-view device, in which images can be viewed from the front side of the transparent substrate 20, which in this example is the side opposite to that upon which the IMOD display elements are formed. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 that provides the ability to separate the optical properties of the modulator from the electromechanical properties of the modulator, such as voltage addressing and the movements that result from such addressing.

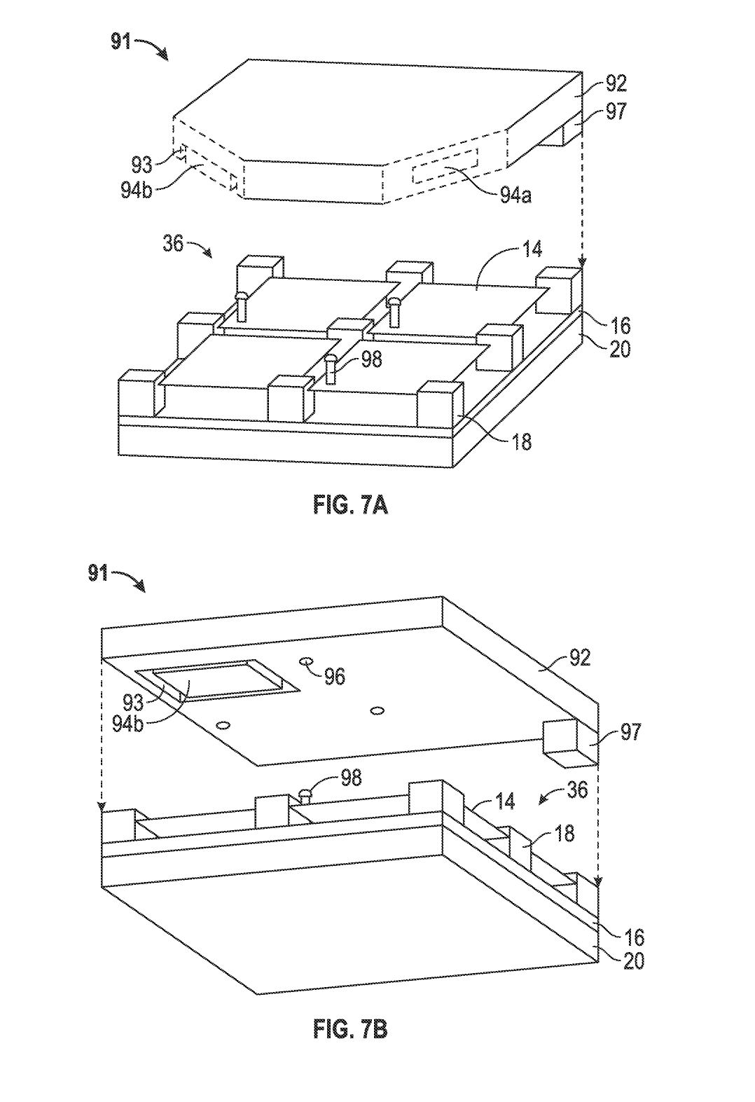

FIGS. 7A and 7B are schematic exploded partial perspective views of a portion of an EMS package 91 including an array 36 of EMS elements and a backplate 92. FIG. 7A is shown with two corners of the backplate 92 cut away to better illustrate certain portions of the backplate 92, while FIG. 7B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (e.g., the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 7A and 7B, the backplate 92 can include one or more backplate components 94a and 94b, which can be partially or wholly embedded in the backplate 92. As can be seen in FIG. 7A, backplate component 94a is embedded in the backplate 92. As can be seen in FIGS. 7A and 7B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 7B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 7A and 7B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 7A and 7B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

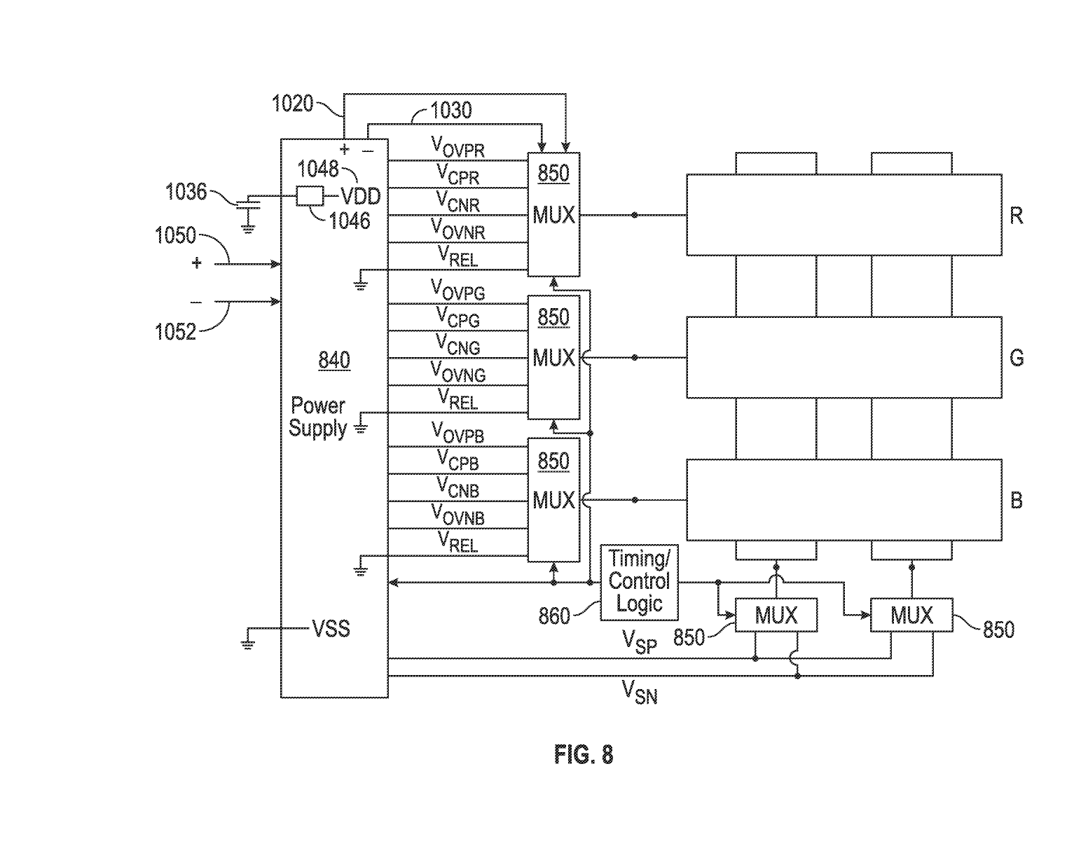

FIG. 8 is a system block diagram illustrating the generation and application of various voltages to a display when using the drive scheme of FIG. 5B. This Figure illustrates an implementation of driver circuitry using a power supply 840 that generates the drive voltages. The various voltages generated would be appropriately combined to produce the illustrated waveforms in FIG. 5B using, for example, multiplexers 850, and timing/controller logic 860. In FIG. 8, the voltages labeled V_{CP} and V_{CN} correspond to the positive and negative hold voltages 72 and 76 of FIG. 5B. The voltages V_{OVP} and V_{OVN} correspond to the write or overdrive voltages 74 and 78 of FIG. 5B. V_{REL} corresponds to the release voltage 70, and V_{SP} and V_{SN} correspond to the positive and negative segment voltages 62 and 64 of FIG. 5B. The subscripts R, G, and B correspond to different color display elements red, green, and blue.

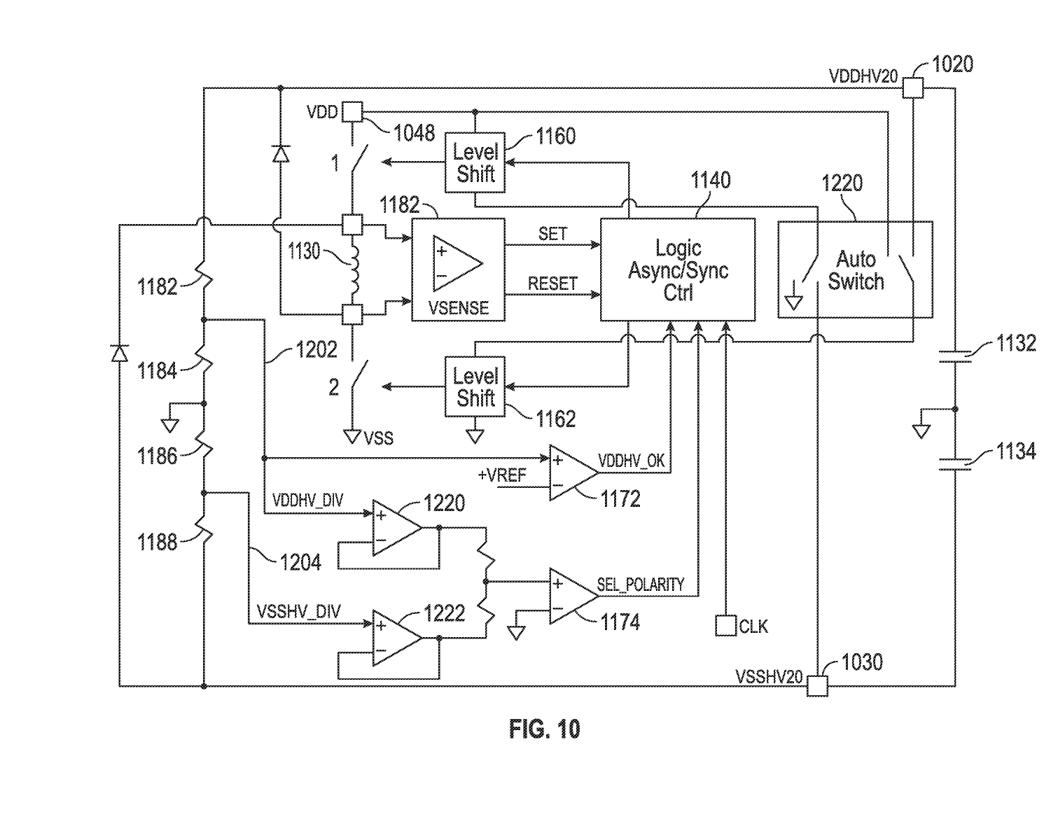

The largest voltages that are switched by multiplexers 850 are the positive and negative overdrive voltages V_{OVP} and V_{OVN}, which may be as large (or even larger) as positive and negative 20 volts. Thus, the multiplexers 850 require positive and negative rail voltages of at least that magnitude, which are shown at lines 1020 and 1030 of FIG. 10. These rail voltages may be derived, at least in part, from a battery 1036 coupled to a regulator 1046 which produces a VDD voltage 1048, which is typically relatively small, such as +3.3 volts. These rail voltages may also be derived from additional voltage inputs to the power supply 840, shown as inputs to power supply 840 on lines 1050, 1052. Because voltages generally used in display devices are low, conventional power supplies in this environment do not generate voltages with magnitudes above about 16 volts, and thus the inputs to the power supply 840 may be limited to values lower than the 20 volt outputs required at lines 1020 and 1030. Accordingly, the power supply 840 may include a voltage converter that produces the higher voltage rails 1020 and 1030 from one or both of VDD and the input voltages 1050 and 1052.

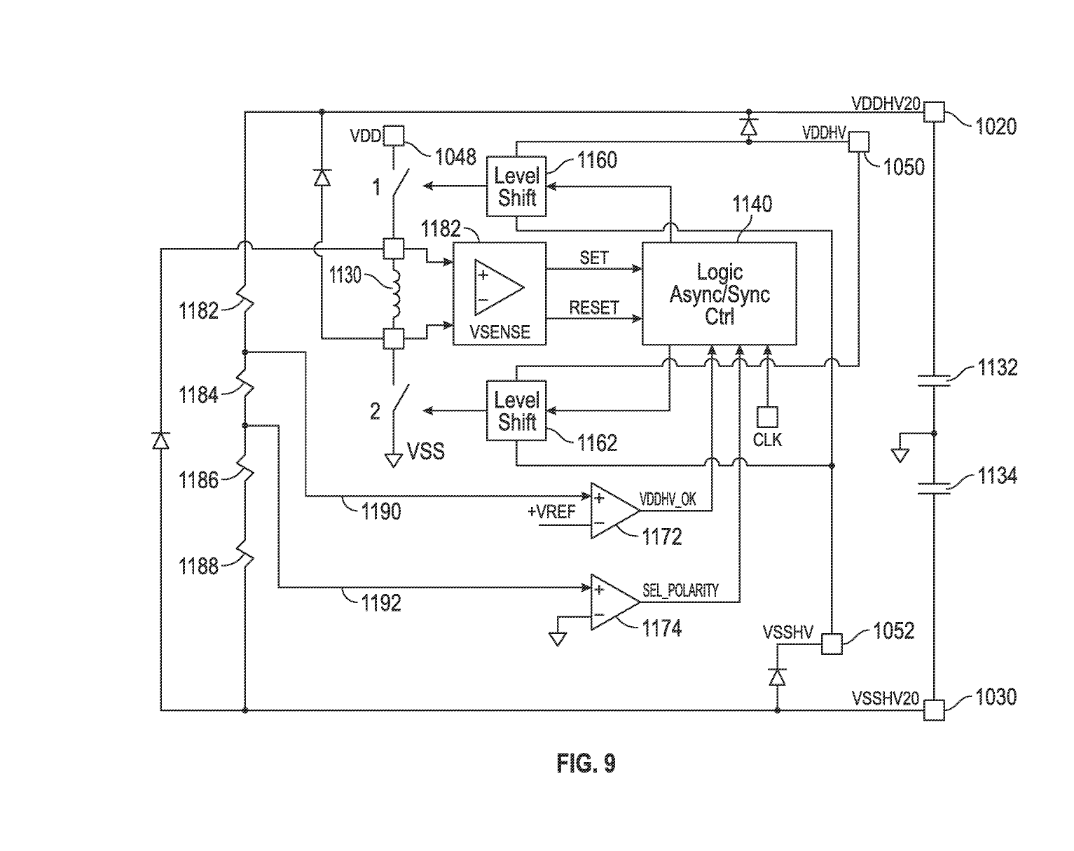

FIG. 9 is a schematic diagram illustrating an implementation of a voltage converter for producing the rail voltages 1020 and 1030 of FIG. 8. The circuit implementation of FIG. 9 may be implemented on a single integrated circuit except for the inductor 1130 and output capacitors 1132 and 1134. Inputs and outputs to and from the integrated circuit are shown as squares. In this circuit, the positive output rail 1020 is produced at node VDDHV20, and the negative output rail 1030 is produced at node VSSHV20. The positive input 1050 to the power supply 840 is provided to node VDDHV, and the negative input 1052 is provided node VSSHV. The converter includes an inductive boost design. Current through inductor 1130 is created by closing switches 1 and 2. When the current reaches a selected amplitude, either switch 2 is opened, forcing charge onto output capacitor 1132 and raising output voltage 1020, or switch 1 is opened, pulling charge from output capacitor 1134, thus lowering the voltage at output 1030. In either case, when the current through the inductor 1130 reaches zero, the closed switch 1 or 2 is opened, and another cycle can be performed if desired. Switches 1 and 2 are driven by level shifters 1160 and 1162 respectively, which are themselves controlled by a logic circuit 1140. The logic circuit 1140 has as inputs the outputs of feedback comparators 1172 and 1174 which monitor the output voltage levels. The logic circuit 1140 also has as inputs the outputs of inductor sense circuit 1182, which provides signals dependent on the current through the inductor 1130 so the switch positions can be timed appropriately according to the current in the inductor. Using the output voltage sensing and inductor current sensing, the logic circuit 1140 controls the level shifters 1060 and 1062 to control switches 1 and 2 to provide charge pulses to output capacitors 1132 and 1134 to maintain the output voltages 1020 and 1030 at the desired levels.

Because of the nature of the switches 1 and 2, it is advantageous for the level shifters 1160 and 1162 to be provided with rail voltages that are similar in amplitude to the output voltages 1020 and 1030. Because in this implementation the switches 1 and 2 may be implemented as FETs on an integrated circuit, they are small in size, and to drive them efficiently with a low on-state resistance a relatively large magnitude negative voltage should be used to drive the gate of p-type transistor switch 1 to turn on the switch 1, and a relatively large magnitude positive voltage should be used to drive the gate of n-type transistor switch 2. For this purpose, the additional supply voltages 1050 and 1052 are used in this implementation. For example, the output voltages 1050 and 1052 may be +20 V and −20 V, and the level shifter rails may be +16 V and −16 V, input to the chip at 1050 and 1052.

The voltage converter of FIG. 9 utilizes a feedback architecture that uses two feedback loops, one of which is used to monitor the average of the two output voltages of the converter To do this, the outputs may be coupled by a set of resistors 1182, 1184, 1186, and 1188 connected in series, all of which may or may not have the same resistance value. One feedback loop includes a sense line 1190 coupled at a node having only one resistor between the node and one of the converter outputs, and three resistors between the node and the other converter output. The voltage on sense line 1190 is compared to a threshold voltage at comparator 1172, which has its output routed to the control circuitry 1140. A second feedback loop includes a sense line 1192 connected to a node having two resistors between the node and each of the two converter outputs. If the resistance is the same on both sides of the node, the voltage on sense line 1192 will be the average of the two converter outputs. During operation, the second feedback loop to the control circuit 1140 will cause the control circuit to maintain the node between resistor 1184 and 1186 at virtual ground due to the grounding of the negative input of comparator 1174. The first feedback loop will cause the control circuit to maintain the node between resistors 1182 and 1184 at the reference voltage +VREF due to the +VREF input to the negative terminal of the comparator 1172.

In the implementation of FIG. 9, when all of the resistors 1182, 1184, 1186, and 1188 are the same resistance (a high resistance to not load the outputs significantly), the outputs will be regulated to be equal and opposite polarity with magnitude of 2*VREF. In general, with resistor values that are not necessarily equal, the second feedback loop will provide an indication to the control circuit of a weighted sum of the two output voltages, defining the asymmetry between the two outputs. The first feedback loop will provide an indication of the positive output voltage to the control circuitry 1140, defining the magnitude of the output voltages with reference to +VREF.

It may also be noted that the sense circuit 1182 may be protected from receiving the high voltage outputs by including additional switches (not shown) in the lines connecting the ends of the inductor to the sense circuit 1182. These switches can be controlled by the control circuitry 1140 so that when switch 2 is open and switch 1 is closed, the lower connection is broken, and when switch 2 is closed and switch 1 is open, the upper connection is broken. When both switches 1 and 2 are closed to produce the charging current in the inductor 1130, both of these switches are closed so that the sense circuit 1182 can monitor the inductor current.

FIG. 10 is a schematic diagram illustrating another implementation of a voltage converter for producing the rail voltages of FIG. 8. In this implementation, however, the additional rail input voltages 1050 and 1052 are not required. In the implementation of FIG. 10, operation is substantially the same as described above with reference to FIG. 9. The difference is that the rails supplied to the level shifters 1160 and 1162 are different. The positive rail for the level shifter 1160 connected to switch 1 is first coupled to VDD (e.g. +3.3 V) and the negative rail for the level shifter 1162 connected to switch 2 is first connected to ground or VSS. In normal operation when the output voltages are at their desired levels (e.g. +20 V and −20 V), a switching circuit 1220 connects the negative rail of level shifter 1160 to the negative output voltage 1030 and connects the positive rail of level shifter 1162 to the positive output 1020. This provides a sufficient voltage across the rails for each of the level shifters 1160 and 1162 to efficiently drive the switches 1 and 2. When the supply is first turned on, however, the output voltages 1020 and 1030 are very low. The low voltage conditions on the outputs 1020, 1030 may not allow proper operation of level shifters 1160 and 1162 if they were connected to the converter outputs at this time. Therefore, at start up, the switching circuit 1220 connects the negative rail of level shifter 1160 to ground or VSS, and the positive rail of level shifter 1162 to VDD. Although the voltages provided to the level shifters are small at this time, they are high enough to operate the level shifters 1160 and 1162 and drive the switches 1 and 2. After the output voltages 1020 and 1030 rise, the switching circuit 1220 switches the level shifter inputs to the outputs 1020 and 1030 for normal operation. During start-up, this transition may occur when the outputs are, for example, at about a magnitude of seven volts, as sensed by an output voltage sensor in the switching circuit 1220. The transition may also be based on an elapsed time from start up.

The voltage converter of FIG. 10 utilizes a feedback architecture that uses a first feedback loop to directly monitor one of the two voltage converter outputs, and a second feedback loop to monitor a weighted sum of the two output voltages of the converter. As with FIG. 9, the outputs may be coupled by a set of resistors 1182, 1184, 1186, and 1188 connected in series, all of which may or may not have the same resistance value. In the implementation of FIG. 10, the center of the set of resistors is grounded. A first sense line 1202 is coupled at a node that is has one resistor to ground, and one resistor to one of the converter outputs. The voltage on this sense line 1202 will depend only on the output voltage of the output that is one resistor away. This sense line is routed to comparator 1172, where the voltage on sense line 1202 is compared to a reference voltage +VREF. The reference voltage and the resistance values for resistors 1182 and 1184 may be selected such that the comparator 1172 output is high if the output at 1020 is too high, and is low if the output at 1020 is too low. A second sense line 1204 is connected in the same location as sense line 1202 but on the other side of the central grounded node. The voltage on this sense line 1204 will depend only on the other output voltage. Sense lines 1202 and 1204 are each routed to buffers 1220 and 1222, which have their outputs connected to a two resistor summing network. The voltage at the central node of these two resistors is routed to comparator 1174 where this voltage is compared to ground. The output of the comparator 1174 is routed to the control circuitry. The state of the output of comparator 1174 will change, depending on whether a weighted sum of the two output voltages is above or below zero. As with the implementation of FIG. 9, when all of the resistors 1182, 1184, 1186, and 1188 are the same resistance, the outputs will be regulated to be equal and opposite polarity with magnitude of 2*VREF. In general, with resistor values that are not necessarily equal, the second feedback loop will provide an indication to the control circuit of a weighted sum of the two output voltages, defining the asymmetry between the two outputs. The first feedback loop will provide an indication of the positive output voltage to the control circuitry 1140, defining the magnitude of the output voltages with reference to +VREF.

The control circuitry 1140 may monitor the two outputs from the comparators 1172 and 1174 to decide which output, if any, to boost with the inductor. This is useful at start up to raise the voltages together. For example, at startup, before the output voltages have reached their desired output levels, the output of comparator 1172 will be low. The output of comparator 1174 will be either low or high depending on which output is closer to the desired output value. The control circuit can decide to provide a charge boost to which ever output is farthest from regulation. As the voltages rise to their desired level, the control circuit will alternate between boosting the two outputs, keeping them close to the same level as they both rise to the desired output voltages. With this implementation, both outputs are regulated against a common reference voltage +VREF.

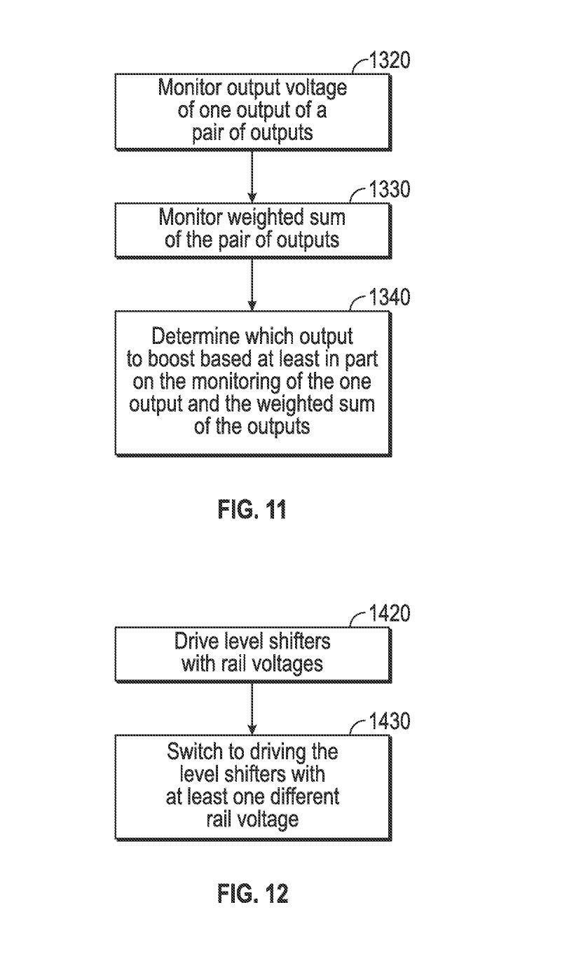

FIG. 11 is a flowchart illustrating a mode of operation for a voltage converter, the voltage converters of FIGS. 9 and 10 for example. In this example method, the method starts at block 1320, where one output of a pair of voltage converter outputs is monitored. At block 1330, a weighted sum of the pair of outputs is also monitored. At block 1340, a determination of which output to boost is based at least in part on the monitoring.

FIG. 12 is a flowchart illustrating another mode of operation for a voltage converter, the voltage converters of FIGS. 9 and 10 for example. In this example method, the method starts at block 1420, where one or more level shifters in a voltage converter are driven with rail voltages. At block 1430, the converter switches to driving the one or more level shifters with at least one different rail voltage.

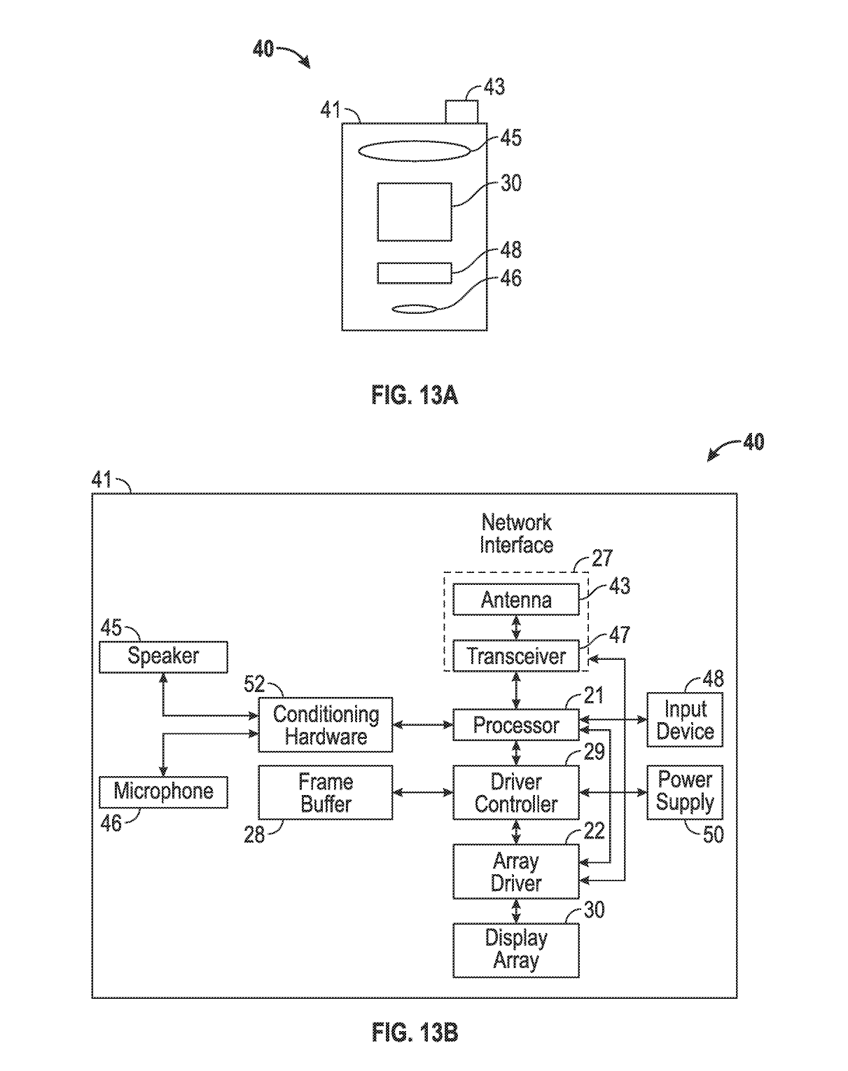

FIGS. 13A and 13B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 13B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 13B, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A voltage converter comprising:
first and second voltage outputs of opposite polarity;
an inductor;
a first switch having an input coupled to a first inductor rail voltage and an output coupled to an input of the inductor;
a second switch having an input coupled to an output of the inductor and an input coupled to a second inductor rail voltage;
a first level shifter having an output coupled to the first switch to control the on/off state of the first switch and having one or more inputs coupled to one or more level shifter rail voltages;
a second level shifter having an output coupled to the second switch to control the on/off state of the second switch and having one or more inputs coupled to the one or more level shifter rail voltages;
control circuitry coupled to the first and second level shifters;
a first feedback loop configured to provide an indication of the output voltage at one of the first and second voltage outputs to the control circuitry; and
a second feedback loop configured to provide an indication of a weighted sum of the first and second output voltages to the control circuitry.

2. The voltage converter of claim 1, wherein the first and second voltage outputs have a magnitude of 20 V or more.

3. The voltage converter of claim 2, wherein the one or more level shifter rail voltages are 16 V or less.

4. The voltage converter of claim 1, additionally comprising a switching circuit for switching the level shifter rail voltages from one voltage level to a second voltage level during operation of the voltage converter.

5. The voltage converter of claim 1, wherein the first feedback loop is configured to compare the output voltage at one of the first or second voltage outputs to a reference voltage.

6. The voltage converter of claim 5, wherein the second feedback loop is configured to compare the average of the first and second output voltages to ground.

7. A display apparatus comprising the voltage converter of claim 1.

8. The display apparatus of claim 7, further comprising:
a display;
a processor that is configured to communicate with the display, the processor being configured to process image data; and
a memory device that is configured to communicate with the processor.

9. The display apparatus of claim 8, further comprising:
a driver circuit configured to send at least one signal to the display; and
a controller configured to send at least a portion of the image data to the driver circuit.

10. The display apparatus of claim 8, further comprising:
an image source module configured to send the image data to the processor, wherein the image source module comprises at least one of a receiver, transceiver, and transmitter.

11. The display apparatus of claim 8, further comprising:
an input device configured to receive input data and to communicate the input data to the processor.

12. The display apparatus of claim 8, wherein the display comprises electromechanical display elements.

13. A method of operating a voltage converter having at least one pair of outputs of opposite polarity, the method comprising:
monitoring an output voltage at one of the outputs of the pair;
monitoring a weighted sum of the output voltages of the pair of outputs; and
determining which output to boost based at least in part on the output voltage at one of the outputs and the weighted sum.

14. The method of claim 13, wherein monitoring an output voltage at one of the outputs of the pair includes comparing the output voltage at one of the outputs of the pair to a reference voltage.

15. The method of claim 13, wherein monitoring the average output voltage of the pair of outputs includes comparing the average output voltage of the pair of outputs to ground.

16. A voltage converter comprising:
means for boosting a pair of voltage outputs having opposite polarity;
means for monitoring an output voltage at one of the outputs of the pair;
means for monitoring a weighted sum of the output voltages of the pair of outputs; and
control circuitry for determining which output to boost based at least in part on the output voltage at one of the outputs and the weighted sum.

17. The voltage converter of claim 16, wherein the means for boosting includes an inductor.

18. The voltage converter of claim 16, wherein the means for monitoring an output voltage at one of the outputs of the pair includes a comparator.

19. The voltage converter of claim 16, wherein the means for monitoring the average output voltage of the pair of outputs includes a comparator.

20. A voltage converter comprising:
first and second voltage outputs of opposite polarity;
an inductor;
a first switch having an input coupled to a first inductor rail voltage and an output coupled to an input of the inductor;
a second switch having an input coupled to an output of the inductor and an input coupled to a second inductor rail voltage;
a first level shifter having an output coupled to the first switch to control the on/off state of the first switch and having one or more inputs coupled to one or more level shifter rail voltages;
a second level shifter having an output coupled to the second switch to control the on/off state of the second switch and having one or more inputs coupled to one or more level shifter rail voltages;
control circuitry coupled to the first and second level shifters;
a switch circuit configured to switch at least one level shifter rail voltage from one voltage level to a second voltage level during operation of the voltage converter.

21. The voltage converter of claim 20, wherein the first and second voltage outputs have a magnitude of 20 V or more.

22. The voltage converter of claim 21, wherein the one or more level shifter rail voltages are 16 V or less.

23. The voltage converter of claim 20, wherein the switch circuit is configured to switch a level shifter rail voltage from an inductor rail voltage to a voltage output.

24. A display apparatus comprising the voltage converter of claim 20.

25. The display apparatus of claim 24, further comprising:
a display;
a processor that is configured to communicate with the display, the processor being configured to process image data; and
a memory device that is configured to communicate with the processor.

26. The display apparatus of claim 25, further comprising:
a driver circuit configured to send at least one signal to the display; and
a controller configured to send at least a portion of the image data to the driver circuit.

27. The display apparatus of claim 25, further comprising:
an image source module configured to send the image data to the processor, wherein the image source module comprises at least one of a receiver, transceiver, and transmitter.

28. The display apparatus of claim 25, further comprising:
an input device configured to receive input data and to communicate the input data to the processor.

29. The display apparatus of claim 25, wherein the display comprises electromechanical display elements.

30. A method of operating a voltage converter having at least one pair of outputs of opposite polarity, the method comprising:
driving a level shifter with a first rail voltage; and
switching from driving the level shifter with the first rail voltage to a second rail voltage different from the first rail voltage.

31. The method of claim 30, comprising driving a boost inductor with the first rail voltage.

32. The method of claim 30, wherein the second rail voltage is a voltage converter output.

33. A voltage converter comprising:
means for boosting a pair of voltage outputs having opposite polarity;
means for driving a level shifter with a first rail voltage; and
means for switching from driving the level shifter with the first rail voltage to a second rail voltage different from the first rail voltage.

34. The voltage converter of claim 33, wherein the means for boosting includes an inductor.

35. The voltage converter of claim 34, further comprising means for driving the inductor with the first rail voltage.

36. The voltage converter of claim 35, wherein the means for switching includes means for switching the level shifter rail voltage to an output voltage of the voltage converter.
